(19) United States
(12) Patent Application Publication
(10) Pub. No.: US 2021/0316345 A1
(43) Pub. Date: Oct. 14, 2021

(54) METHOD AND SYSTEM FOR PROCESSING ORGANIC WASTE

(71) Applicant: Scandi Energy AS, Langhus (NO)

(72) Inventor: Tommy Schierning, Ski (NO)

(73) Assignee: Scandi Energy AS, Langhus (NO)

(21) Appl. No.: 17/268,165

(22) PCT Filed: Aug. 13, 2019
(86) PCT No.: PCT/EP2019/071723

§ 371 Date: Feb. 12, 2021

(30) Foreign Application Priority Data
Aug. 13, 2018 (NO) 20181068

(51) Int. Cl. B09B 3/00; B03C 5/00; C10J 3/66

(52) U.S. Cl. CPC B09B 3/0083; B30B 9/02; C10J 3/66; B03C 5/00

(57) ABSTRACT

A method for processing organic waste comprises two steps. Step one comprises separating water from the organic waste to produce liquid, slurry and solid matter, and step two comprises gasification of the slurry and solid matter. A system for processing organic waste and generate energy comprises a screw-press solid separator adapted for receiving the organic waste and expel liquid from the organic waste to produce water, slurry and solid matter, and a multi-stage gasifier for gasification of the slurry and solid matter.

The invention regards a method and system for processing organic waste.

One of the essential problems for establishing a sustainable society for human beings without destroying the material circulation system on the limited earth, is to create renewable clean energy which does not use an exhaustible resource such as fossil fuel or uranium or destroy the resource environment. That is, there is a demand for renewable energy which discharges a small amount of harmful substances when being converted to effective energy such as electricity and heat so as to be used by human beings and which is produced by using permanently usable energy sources such as sunlight, wind power, water power, natural steam, and biomass. Practical use of these energy sources is increasing because of their attractive characteristics. However, in any case, there are various inherent problems concerning the final costs.

In the case where biomass is used as an energy source, energy conversion is performed using heat which is obtained by directly burning organic waste derived from living resources, or carbonized, liquefied, or gasified fuel. Accordingly, this case has the feature of making a significant contribution over establishment of a recycling-based society, which results in reuse of waste or reduction in waste, but has not only an infrastructure-relating problem in that the cost for collecting, delivering, and managing the resources is required because such resources are dispersed over a wide range, but also a technical problem in that the combustion efficiency or the efficiency of conversion to fuel is not good, for example. Accordingly, various systems including an organic waste carbonizing system (NPL 1) and a charcoal syngas production system (PTL 1) have been developed.

Olive Mill Waste (OMW) is the liquid (slurry) waste product from the production of olive oil. Generally, a result of a second extraction process following the production of virgin olive oil.

At the turn of the century about 40 million cubic metres of OMW produced in the Mediterranean basin. The characteristics of OMW naturally vary from country to country and extraction process to extraction process. In the main the OMW varies from as little as 3% Total Solids (TS) to as much as 11% TS. Of these solids between 85% and 95% are classified as Volatile Solids (VS).

Apart from fragments of the olive nuts and flesh, much of the solids are in the form of residual oils. The OMW contains long chain fatty acids in the form of lignin and tannins, from which the OMW gets its dark colour. Most importantly the OMW is rich in phenols and flavonoids. In many cases these compounds become polymerised in the second stage of olive oil extraction.

These phenolic compounds at are extremely toxic for micro-organism and plants. The high recalcitrant organic load and toxicity of the OMW necessitates its treatment, however efficient treatment has not been found and this presents a problem for all countries in the Mediterranean region. Regulations for the disposal of OMW are virtually non-existent.

Much of the OMW is dumped to landfill or discharged to sea. Others store the OMW in shallow lagoons where moisture is evaporated over time and the resulting dry material is then spread in the olive groves. Some have used anaerobic digestion techniques, where the OMW is significantly water down, but the retention time for digestion is very long, 4 to 6 months, requiring very large and costly systems.

Incineration is both difficult in relation the amount of water, and once burnt, the flue gas is toxic and requires extensive cleaning before release to the atmosphere.

As a result, the production and disposal of OMW is a significant problem for the olive growing areas of the world, creating environmental and health problems when not adequately treated.

The object of the invention is to provide a method and system for processing organic waste, which results in both usable water and material usable for fuel, with a low or nearly no amount of residue waste to be deposited or handled.

The object of the invention is provided by means of the features of the patent claims.

In one embodiment, a method for processing organic waste comprises two steps, where step one comprises separating water from the organic waste to produce water, slurry and solid matter, and step two comprises gasification of the slurry.

Correspondingly, a system for processing organic waste and generate energy comprises in one embodiment a screw-press solid separator adapted for receiving the organic waste and expel liquid from the organic waste to produce water, slurry and solid matter, and a multi-stage gasifier for gasification of the slurry and solid matter.

The organic waste is for example produced from olive oil production, but as discussed above, the method and system may be used for all kinds of organic waste and/or any kind of carbonaceous sludge, mud or other kinds of waste. The method and system may for example be used to process wet organic waste from sewage, waste from aquaculture/fish farming, waste from oil or gas refineries or other petroleum installations, etc.

The step of separating water from organic waste comprises in one embodiment pressing the organic waste in order to expel liquid from the organic waste. The pressing of the organic waste can for example be done by passing the organic waste through a screw-press solid separator as mentioned above.

Further, the step of separating water from organic waste may further comprise removing solid materials and oils from the liquid expelled from the organic waste. This is in one embodiment done by processing the liquid by means of an electro-static coagulation device which comprises ultrasound transducers to separate the solid materials and oils from the liquid and collect the separated solid materials and oils. The electrostatic coagulation device may be an electrostatic flocculation device with a separating device.

The gasification comprises in one embodiment two stages, the first stage comprising pyrolysis of the slurry and solid matter and outputting matter to the second stage, and the second stage comprising adding steam to the output matter.

In other embodiments, the gasification may comprise more than two stages, being a multi stage process, comprising further gasification stages replacing or being added to the two stages described above. In the following description, the gasification will be described as a two-stage process.

The gasification step may also comprise drying the slurry and solid matter to obtain a material with moisture content between 10% to 15%. The dried material can be used in the first stage of the gasification process. For this purpose, the system may comprise a dryer.

The system may also, in some embodiments, comprise a drying step prior to the gasification step, for example vacuum drying, by means of a vacuum dryer or other suitable kind of dryer.

The syngas produced in this process is a storable and versatile fuel and can be converted to different liquid fuels. The second gasification stage in the process resolves oil and tar problems by carbonizing these together with remaining solids. The addition of steam enhances hydrogen production. Biochar, the remaining material, is an excellent soil enhancer and fertilizer. Heavy metals are bonded with the carbon and become inert, while nutrients like nitrogen, phosphorus, potassium have looser bonds and remain accessible to plants. Biochar is effective for soil moisture retention and carbon replenishment. Alternatively, biochar can also be processed for extraction of carbon black (used in composites and car tyres).

As in this way all the products resulting from the method and system may be used for different purposes, the result is zero or very little waste which must be deposited or otherwise handled.

The invention will now be described by means of example and by reference to the accompanying figures.

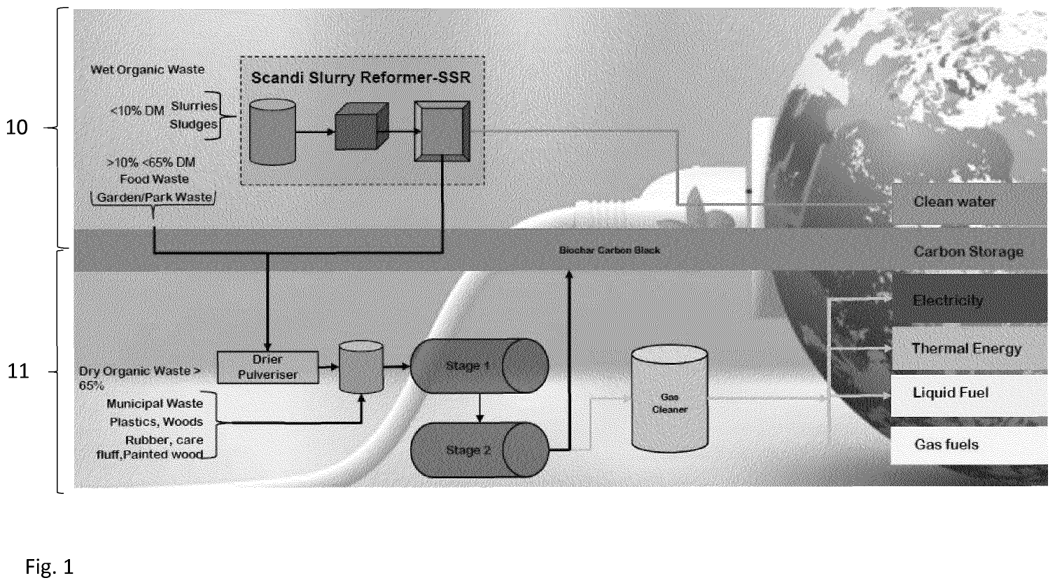

FIG. 1 schematically illustrates an overview of the use of the method for processing organic waste.

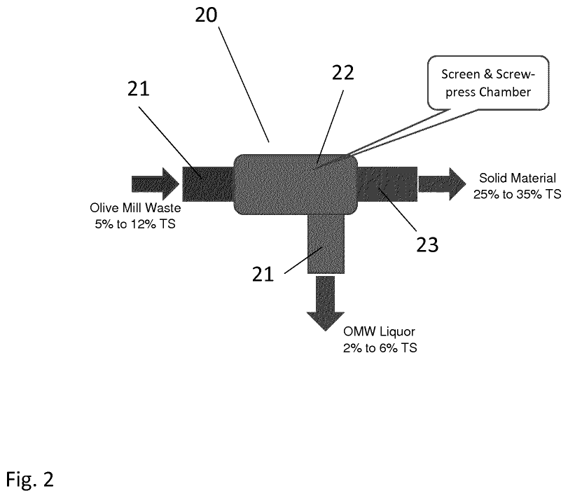

FIG. 2 illustrates the first stage of the first step of a method for processing organic waste, for example by using a screw-press separator

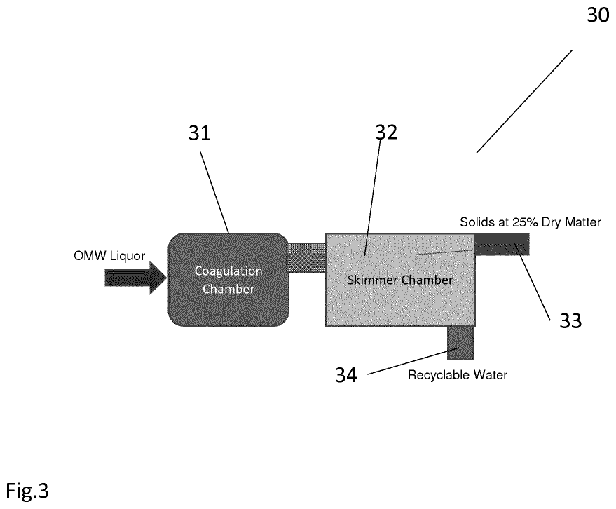

FIG. 3 illustrates another stage of the first step of a method for processing organic waste.

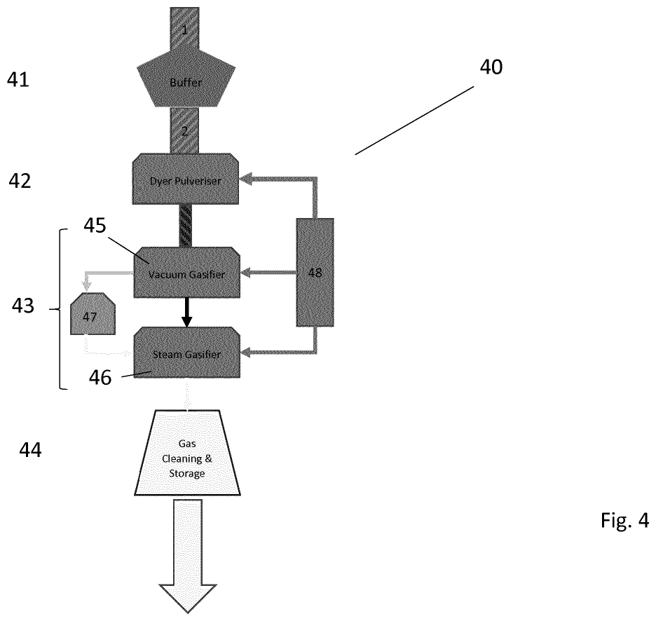

FIG. 4 illustrates an example of a gasification process for use as step two in a method for processing organic waste.

In FIG. 1 the method for processing organic waste and the features achieved by the method is schematically illustrated. The method comprises two steps, where step one is shown in the upper part 10 of the illustration and comprises separating water from the organic waste to produce liquid, slurry and solid matter. Step two is illustrated in the lower part of the illustration and comprises gasification of the slurry and solid matter. Further details of the two steps will be described below with reference to FIGS. 2-4. In the following description, olive mill waste is used as example of the organic waste material, but as discussed earlier in this document, the method and system can be used to process other kinds of organic waste materials.

FIG. 2 illustrates an example of one stage, separation, of the first step of a method for processing organic waste, by using a screw-press separator 20. The screw-press separator 20 separates water from the organic waste to produce water, slurry and solid matter. The organic waste, such as Olive Mill Waste is introduced through an inlet 21 to a screen and screw-press chamber 22 where liquor is pressed out and is expelled through liquor exit 21. The remaining screen solid material is expelled from solid material exit 23 in the form of a moist paste with a portion of dry matter for example between 25% and 35%. The solid material is collected for subsequent feeding to the gasifier's drier.

The liquor from liquor exit 21 in FIG. 2 is rich in colloidal oils, fats and organic compounds. This liquor is in this example introduced into an electro-static coagulation device 30 illustrated in FIG. 3. In this stage, the liquor is first introduced to a coagulation chamber 31 comprising ultra-sonic transducers. The use of the ultrasonic transducers on the liquor causes the breakup of colloidal structures and excites any suspended solids in the liquor. Ionic free radicals emitted to the liquor cause coagulation of the solid material and oils. Micro-bubbling, ie. the application of micro-bubbles to the liquor, for example caused by an electrolysis process, causes these coagulated solids to float to the surface of the liquor. The floated coagulant is then skimmed in skimmer chamber 32. The skimmed material can by this process obtain a dry matter content of between 20% and 30%. The skimmed material is collected through exit 33 for feeding to the subsequent gasification step. The remaining liquid from the skimming chamber is let out through exit 34 to be recycled as water.

The coagulation process may be performed by an electrolysis process, where a DC charge to the liquor material produces hydroxide free radicals (OH—) in the liquor. These charged particles break the valency bonds of the nutrient salts in the liquor, enabling them to floc with the solid particles.

The electrolysis process emits ions from the electrode that through their charge attract the suspended material. Micro bubbles produced from the electrolysis accelerate the flotation of the floc; or alternatively, micro ballast material can be added to accelerate the sedimentation of the floc through a lamella arrangement.

The process stages illustrated in FIGS. 2 and 3 has both produced dry material, which is used in step two of the method, for gasification using a gasifier 40. This step is illustrated in FIG. 4.

The solid material from the separator 20 and coagulation device 30 are fed to a Buffer Storage 41 to allow for non-stop operation of the gasifier. The buffer 41 may comprise sensors measuring the amount of material present in the buffer. Sensor signals may be used by a control system to control the feeding from the previous stages to the buffer and for feeding dry matter from the buffer to the subsequent processing stages.

From the buffer 41, the dry material is passed to a drier 42 that operates at a temperature of 105° C. to 160° C., depending on the nature of the material being dried. The drier 42 dries and grinds the material until it has a moisture content of between 10% to 15%. The material is in one example ground to a powder. This amount of moisture enables a better cracking of long chain fatty acids and other large hydrocarbon molecules.

In some embodiments, there may also be an additional drying step, for example vacuum drying, by arranging a vacuum drier prior to the gasification. The vacuum drier may be arranged before or after the buffer storage 41. Vacuum drying applies a vacuum to the material to decrease the pressure below the vapor pressure of the water. With the help of vacuum pumps, the pressure is reduced around the substance to be dried. This decreases the boiling point of water inside that product and thereby increases the rate of evaporation.

Once dried the material is passed to the first stage of the gasification process, using a gasifier 43. The gasifier 43 comprises a first chamber 45 and a second chamber 46. The first chamber 45 may be provided with a helix transport screw arrangement, or other transport arrangement/device for feeding the dry material to a pyrolysis zone comprising a pyrolysis reactor for gasification of the dry material by means of pyrolysis in the chamber 45. The chamber 45 has an under pressure of around −3 mBar and pyrolysis is in this example performed at 600° C. The pyrolysis in the first chamber 45 produces gas which subsequently is passed to the second chamber 46 by means of a vacuum generator 47 along with char produced as a bi-product of the pyrolysis process in the first chamber 45.

In the second chamber 46 steam is added to the mixture of gas and char by means of a heat and steam generator 48, to provide gasification at a high temperature, for example 88° C. The addition of steam improves the cracking of vaporized tars and oils that may have been present in the gas and char from the first process stage.

As in the first chamber 45, gas and char entering the second stage may be transported into the gasification zone by a helix function.

The feeding of the gasification system is such that the amount of air entering the system with the feedstock material is very small. The chambers of both the first and second stages are indirectly heated by means of the heat and steam generator 48, thus ensuring that no air (in particular nitrogen) is being introduced to the system.

The gasification process in the second chamber 46 results in gas and bio-char. The bio char is taken to a storage and represents the residue waste which is significantly reduced in volume from the initial waste. The gas is quenched and cleaned to separate out tars and oils which may be returned to the second chamber for further processing or transported away for disposal.

Because of the two-stage process, there is very little hydrogen left in the bio-char at the end of the process. Neither are substantially amounts of tar or oils condensed when the gas is quenched and cleaned 44.

As described above, this process is closed and anaerobic (ie. without oxygen), which means that there is very little exhaust/air pollution from this method. The pulverization technique used in the drier 42 enables stable pyrolysis with variable waste streams and is applicable for heterogenous and difficult waste streams with high gate fees.

Table 1 shows typical gas production values of the gas exiting from the final gasification stage described above.

TABLE 1

| | % | BtU/Ft3 |
|---|---|---|
| Hydrogen | 37.1 | 325 |
| CO | 8.5 | 321.0000 |
| Methane | 25.5 | 1012.3 |
| Ethane | | 1773.8 |
| Propane | | 2522 |
| i-Butane | | 3259.5 |
| n-Butane | | 3269.9 |
| i-Pentane | | 4010.2 |
| n-Pentane | | 4018 |
| C6+ | | 5194.5 |
| Oxygen | | 0 |
| Nitrogen | | 0 |
| CO2 | 15.4 | 0 |
| Ethylene | 13.5 | 1613.8 |
| Total | 100 | |

1. A method for processing organic waste, comprising two steps, where step one comprises:
separating water from the organic waste to produce liquid, slurry and solid matter by:
pressing the organic waste in order to expel liquid from the organic waste to produce liquid, slurry and solid matter,
processing the liquid by means of an electro-static coagulation device comprising ultrasound transducers to separate the solid materials and oils from the liquid, and
collecting the separated slurry, solid materials and oils from the pressing and from processing the liquid and water for recycling;
and step two comprises:
gasification of the slurry and solid matter to produce gas and biochar.

2. (canceled)

3. The method according to claim 1, where the step of separating liquid from the organic waste comprises processing the organic waste through a screw-press solid separator in order to expel liquid from the organic waste.

4. (canceled)

5. (canceled)

6. The method according to claim 1, where the step of gasification comprises drying the slurry and solid matter to obtain a dry material with moisture content between 10% to 15%.

7. The method according to claim 1, where the gasification comprises two stages, the first stage comprising pyrolysis of the dried slurry and solid matter and outputting matter to the second stage, and the second stage comprises adding steam to the output matter.

8. The method according to claim 1, where the organic waste is residue from olive oil production.

9. The method according to claim 1, further comprising vacuum drying the slurry and solid matter provided by step one and providing the vacuum dried slurry and solid matter to step two.

10. A system for processing organic waste and generate energy comprising:
a screw-press solid separator adapted for receiving the organic waste and expelling liquid from the organic waste to produce water, slurry and solid matter, an electro-static coagulation device comprising ultrasound transducers, to separate solid materials and oils from the liquid and collect the separated solid materials and oils, and
a multi-stage gasifier for gasification of the slurry and solid matter.

11. (canceled)

12. (canceled)

13. The system according to claim 10, comprising a drier adapted for drying the slurry and solid matter to obtain a material with moisture content between 10% to 15%.

14. The system according to claim 10, where the organic waste is residue from olive oil production.

15. The system according to claim 10, further comprising a dryer for drying the slurry and solid matter and providing dried slurry and solid matter to the multi-stage gasifier.
